(19) United States
(12) Patent Application Publication
(10) Pub. No.: US 2006/0236250 A1
(43) Pub. Date: Oct. 19, 2006

(54) Data display methods, display systems, network systems, and articles of manufacture

(76) Inventor: Ullas Gargi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/106,877

(22) Filed: Apr. 14, 2005

(51) Int. Cl. G06F 17/00; G06F 3/00

(52) U.S. Cl. 715/753

(57) ABSTRACT

Data display methods, display systems, network systems, and articles of manufacture are described. According to one embodiment, a data display method includes providing a plurality of display source devices, providing a display sink system configured to depict visual images, specifying a source display rule associated with display data of one of the display source devices, wherein the source display rule is configured to control the depiction of the display data of the respective one of display source devices by the display sink system, specifying a sink display rule configured to control the display of images using the display sink system, outputting the display data of the one of the display source devices and the source display rule for communication to the display sink system, analyzing the source display rule and the sink display rule, and using the display sink system, depicting the display data of the one of the display source devices responsive to the analyzing.

### FIELD OF THE DISCLOSURE

Aspects of the disclosure relate to data display methods, display systems, network systems, and articles of manufacture.

### BACKGROUND OF THE DISCLOSURE

Display apparatus are becoming more important as devices for consuming information and multimedia. Where a person may have used a monitor and a television for productivity and entertainment, respectively, there is now an increased likelihood that an individual may use multiple monitors, flat panel displays, PDA displays, cell phone displays, projector displays, etc. for conveying information. In addition, displays are now routinely shared locally and remotely, for example, using shared projectors, networked projectors, etc.

There exist today methods and systems for routing, collaborative authoring, and access control of documents (e.g., email, address books, access control lists, encryption, etc.). There is also a need for methods and systems to allow displays (e.g., projectors) to be shared and to control how displays are shared. Some wireless projector configurations permit one input source to be active at one time without providing or enabling composition. Microsoft Netmeeting is built on top of a remote desktop protocol and may also be used for the Mira smart display concept from Microsoft Corporation. However, Microsoft Netmeeting and Mira are inapplicable to projector configurations. X Windows provides a networked graphical environment where displays (e.g., monitor content) may be shared, but typically capability does not exist for specifying finer granular regions or applications. In X Windows, authority is granted from the displayer (server, receiver of display data) to the displayee (client, sender of data).

At least some aspects of the disclosure facilitate sharing of data for display between different devices.

### SUMMARY

According to some aspects, data display methods, display systems, network systems, and articles of manufacture are described.

According to one aspect, a data display method comprises providing a plurality of display source devices, providing a display sink system configured to depict visual images, specifying a source display rule associated with display data of one of the display source devices, wherein the source display rule is configured to control the depiction of the display data of the respective one of display source devices by the display sink system, specifying a sink display rule configured to control the display of images using the display sink system, outputting the display data of the one of the display source devices and the source display rule for communication to the display sink system, analyzing the source display rule and the sink display rule, and using the display sink system, depicting the display data of the one of the display source devices responsive to the analyzing.

According to another aspect, a display system comprises a display device configured to depict visual images to be viewed by a user, a communications interface configured to receive display data and a respective source display rule, wherein the display data corresponds to an image to be generated by the display device and the source display rule is configured to control the depiction of the display data by the display device, and processing circuitry configured to access the source display rule, to identify a conflict with respect to depiction of the display data using the display device in accordance with the source display rule, to resolve the conflict, and to control the display device to depict the image corresponding to the display data in accordance with the resolution of the conflict.

Other embodiments and aspects are described as is apparent from the following discussion.

### DESCRIPTION OF THE DRAWINGS

FIG. 1 is a functional block diagram of a network system according to one embodiment.

FIG. 2 is a functional block diagram of a display sink system configured to display images according to one embodiment.

FIG. 3 is an illustrative representation of display of data from a plurality of display source devices in accordance with one embodiment.

FIG. 4 is a flow chart illustrating an exemplary method executed by a display source device according to one embodiment.

FIG. 5 is a flow chart illustrating an exemplary method executed by a display sink system according to one embodiment.

### DETAILED DESCRIPTION

At least some aspects of the present disclosure provide devices, systems and methods for displaying data via visual images. As described below, rules may be specified to control access, communication and/or display of data.

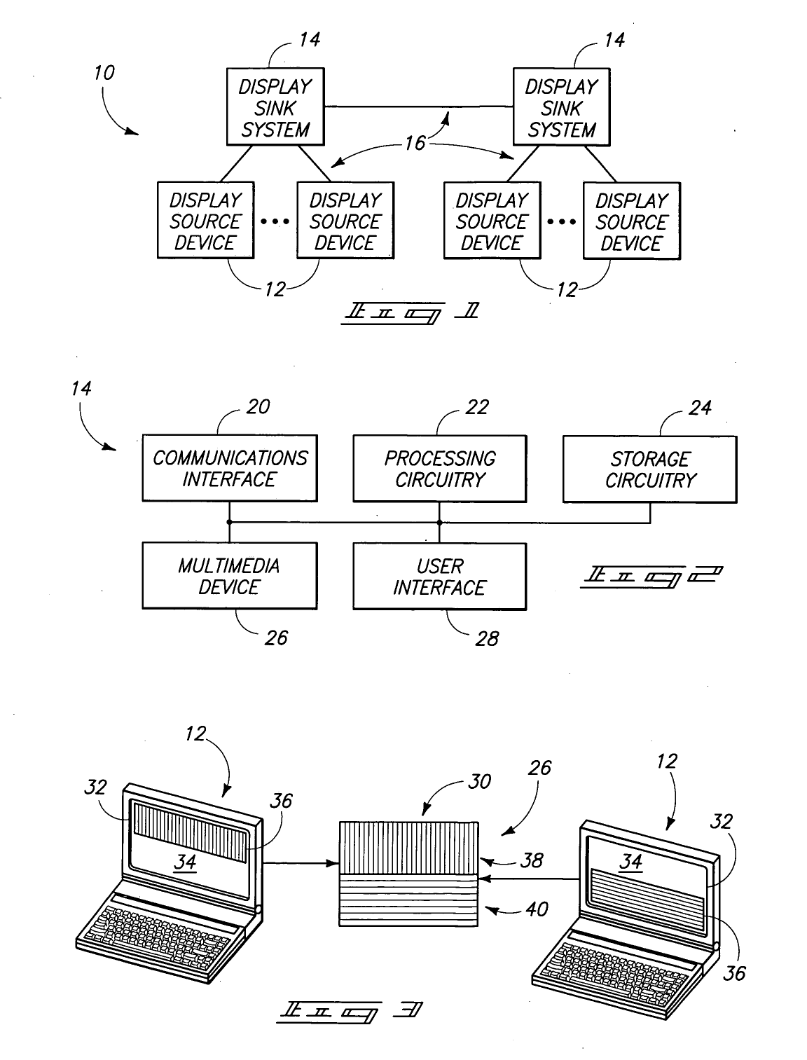

Referring to FIG. 1, a network system 10 includes a plurality of display source devices 12 and a plurality of display sink systems 14 which may also be referred to as display systems. A network including a plurality of network connections 16 may be utilized to communicate data between the connected devices and systems. Exemplary network configurations include any appropriate structure and may implement any appropriate protocol for communicating data between sending and recipient devices using network connections 16. Network connections 16 may include wired and/or wireless (e.g., 802.11) communications media. Possible network configurations are arranged to implement packet-switched communications between the devices and may include private and/or public network connections 16 in one embodiment. Although two display sink systems 14 are shown in FIG. 1, other embodiments may include a single system 14 or additional systems 14.

Display source devices 12 are arranged to formulate display data (e.g., digital and/or analog formats) configured to cause the generation of visual images. In one embodiment, display source devices 12 are configured as computing devices, such as personal computers. Other arrangements of devices 12 for providing display data are possible (e.g., cameras). Display source devices 12 may individually include a display device (e.g., monitor, projector, etc.) configured to display internally generated display data, and/or display received or otherwise accessed display data. In addition, display source devices 12 may also include appropriate communications interfaces for implementing communications with respect to network connections 16. Display source devices 12 may output display data in at least one embodiment to network connections 16 for communication to an external device or system coupled with the network.

According to exemplary aspects described below, display source devices 12 may also be individually arranged to formulate rules or syntax, which may be referred to as display control lists (DCLs), with respect to display data provided by the respective device 12. For example, display source devices 12 may formulate rules which are configured to specify the location where display data provided by the respective device 12 will be depicted on a display device, which parties may have access to the display data and/or control communication of the display data. Other aspects with respect to display data may be specified by the rules in other embodiments as described further below. Individual display source devices 12 may output the rules along with the respective display data to an appropriate network connection 16 for communication to one or more display sink systems 14.

In one embodiment, display sink systems 14 may be configured to generate images which simultaneously depict display data from one or more display source device 12. Display sink systems 14 may implement multiplexing and composition operations with respect to the display of display data. According to additional exemplary aspects, display sink systems 14 may individually communicate some or all of the display data to another display sink system 14 or other appropriate recipient. Display sink systems 14 may also process locally generated (e.g., at the respective system 14) and/or received rules to control the display of digital data and/or the communication of display data to another recipient.

The display sink systems 14 may be associated with a respective entity (e.g., corporation), different entities, different geographical locations (e.g., different conference rooms of an entity), etc. In addition, one or more of the display source devices 12 may be associated with more than one of the display sink systems 14.

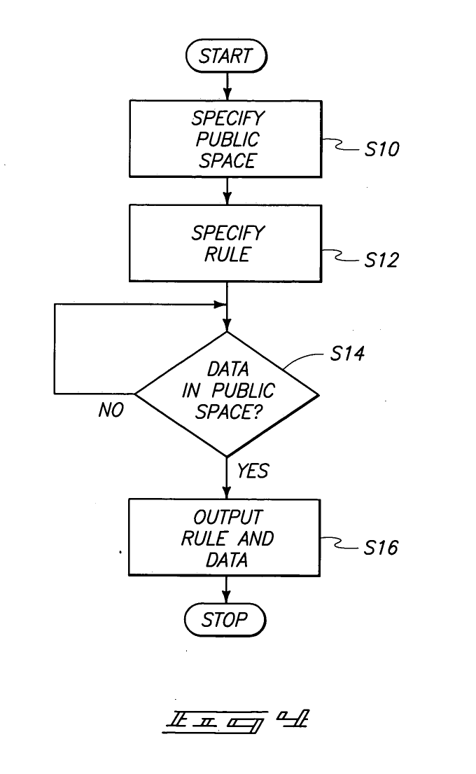

Referring to FIG. 2, an exemplary arrangement of a display sink system 14 is shown according to one embodiment. The illustrated display sink system 14 includes a communications interface 20, processing circuitry 22, storage circuitry 24, a multimedia device 26 and a user interface 28. Other configurations of systems 14 are possible.

Communications interface 20 may provide external bidirectional communications of system 14 via appropriate network connections 16. Communications interface 20 may provide networked communications with respect to one or more of display source devices 12, one or more other display sink system 14 or other external devices. Communications interface 20 may implement wired and/or wireless data communications in exemplary embodiments.

Processing circuitry 22 is configured to access display data and rules locally generated, and/or received from one or more display source device 12, other display sink system 14, and/or other appropriate source. Processing circuitry 22 may implement multiplexing operations with respect to depiction and/or communication of display data from plural display source devices 12 in one embodiment. Processing circuitry 22 may process rules and control the multimedia device 26 to depict the display data and/or implement additional communication of the display data and rules to another display sink system 14 or other recipient in accordance with the rules. Processing circuitry 22 may monitor and/or control other operations of display sink system 14.

In one embodiment, processing circuitry 22 may comprise circuitry configured to implement desired programming provided by appropriate media in at least one embodiment. For example, the processing circuitry 22 may be implemented as one or more of a processor and/or other structure configured to execute executable instructions including, for example, software and/or firmware instructions, and/or hardware circuitry. Exemplary embodiments of processing circuitry 22 include hardware logic, PGA, FPGA, ASIC, state machines, and/or other structures alone or in combination with a processor. These examples of processing circuitry 22 are for illustration and other configurations are possible.

The storage circuitry 24 is configured to store electronic data, programming such as executable instructions (e.g., software and/or firmware), display data, rules, or other digital information and may include processor-usable media. Processor-usable media includes any article of manufacture which can contain, store, or maintain programming, data and/or digital information for use by or in connection with an instruction execution system including processing circuitry 22 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

Multimedia device 26 may include a display device which includes a display (e.g., monitor screen, projector screen, LCD screen, etc.) configured to depict visual images responsive to received display data. Multimedia device 26 may also include loudspeakers or other audio transducers configured to provide audible signals to a user responsive to audible data.

The display device of multimedia device 26 may be provided in various configurations in different embodiments. In one embodiment, display device may be implemented as a monitor. In other embodiments, the display device is implemented as a projector or a screen of a portable device.

A user interface 28 may include a keyboard, mouse or other data input device which a user may access to provide data to the display sink system 14. In one example, a user may input rules (e.g., DCLs described above) configured to control the display of data using the multimedia device 26 and/or external communication of data. Rules provided by a display source device 12 may be referred to as source display rules and rules provided by a display sink system 14 may be referred to as sink display rules. Rules may also be generated by other sources.

In one embodiment, individual ones of display source devices 12 may be configured similar to the exemplary described arrangement of the display sink systems 14.

Individual display sink systems 14 are configured to process rules regarding the display of display data using multimedia device 26. The rules may specify a particular region of a display of multimedia device 26 for depicting respective display data associated with the rules. The rules may also specify whether respective display data may be communicated to other recipients, such as other display sink systems 14. As described further below, individual display sink systems 14 may be arranged to resolve conflicts which may occur between rules for different display data. In one embodiment, the display sink systems 14 may access a policy for resolving conflicts.

Accordingly, in one embodiment as described above, processing circuitry 22 may control the operations of multimedia device 26 to cause the generation of visual images, may also provide multiplexing operations to control the display data which is depicted using the multimedia device 26 of the respective display sink system 14, and may provide communication of the display data to other display sink systems 14 if appropriate.

In other embodiments, a discrete switching device (not shown) separate from but associated with the illustrated components of FIG. 2 of a respective system 14, may be provided to receive the display data and respective rules from the plural display source devices 12 from other systems 14, and/or entered at the respective switching device. The switching device may process the rules to provide multiplexing operations using the rules described above and to output the multiplexed data to communications interface 20 for display using the respective display sink system 14 and/or to another display sink system 14.

Referring to FIG. 3, operations of an exemplary display device of multimedia device 26 are illustrated for depicting display data received from a plurality of display source devices 12. A display 30 (e.g., monitor screen, projection screen, etc.) of a display device of multimedia device 26 may be utilized to depict the digital data. The display device is implemented as a projector in the embodiment of FIG. 3 configured to project a projector display 30 onto an appropriate surface. Exemplary multiplexing operations are described below with respect to the depiction of display data from a plurality of source devices 12.

The display source devices 12 are configured to provide respective display data for depiction using multimedia device 26. In the exemplary embodiment, the respective devices 12 may specify rules which control the communication and depiction of display data by system 14 and may communicate the rules along with the display data to one or more system 14. For example, individual ones of devices 12 may specify that certain display data of the respective device 12 are confidential and other display data may be open for depiction to other parties. In one embodiment, devices 12 may be configured to include regions 34 of their respective display screens 32 which are to be considered as private or confidential, and other regions 36 which are to be considered open to other parties. Regions 34, 36 may be referred to as bounding boxes although other arbitrary shaped regions are possible. The devices 12 may have associated rules to specify that graphical windows appearing in respective regions 34 are not to be communicated to display sink system 14 while display data of windows appearing in respective regions 36 may be communicated to display sink systems 14 or other recipients. Communicated display data may include data content (e.g., text, graphics, etc.) as well as metadata (e.g., controlling width, height and location of a window for depicting the respective display data). Alternatively, display data appearing in one of regions 34, 36 may be restricted to communication to and/or display only by authorized recipients. The association of rules with respective regions 34, 36 may be dynamically applied to respective display data present within the regions 34, 36. For example, the data moved between regions 34, 36 may be subjected to rules of the respective regions 34, 36 in a dynamic manner.

In one embodiment, a user may access a graphical user interface (GUI) or other interface of a respective device 12 to identify and define portions of display screen comprising regions 34, 36. The user may also specify the rules which are to be associated with display data of respective regions 34, 36 (e.g., whether data present in a respective region 34, 36 may be communicated externally, identify recipients entitled to receive the data, etc.).

Accordingly, rules (e.g., DCLs) may specify certain regions of devices 12 which may be open to others (e.g., observed via a display of system 14) providing smaller granularity compared with revealing display data of an entire screen space of a device 12. The rules may specify how respective display data is to be depicted (e.g., specify that less than all of the display data of a respective region 34, 36 may be shown). In addition, other methods may be utilized to specify whether display data of devices 12 is to be considered private or open. Also, in other embodiments, display data of an entire screen may be communicated and access to display data of the entire screen or regions may be restricted pursuant to formulated rules.

Rules generated by users of the devices 12 may control whether display data communicated from the respective devices 12 and addressed and communicated to a first destination (e.g., one of display sink systems 14) may be also communicated to a second destination (e.g., another of the display sink systems 14). In some embodiments, one of the systems 14 may display an entirety of the display data from a device 12 while another of the systems 14 may only display a portion of the display data as specified by the rules. Rules (e.g., DCLs) may define destinations and/or systems 14 configured to access data present within a respective region 34, 36. For example, rules may specify that display data of a respective region 34, 36 may be communicated to devices or systems 14 meeting criteria of a certain class or type (e.g., projector, laptop computer, cell phone, etc.), address (e.g., company intranet addresses), user identification, or other criteria.

The rules may specify the regions or locations 38, 40 of display 30 wherein the display data of the respective device 12 is to be depicted. Referring to the example shown in FIG. 3, the rules may control multimedia device 26 to simultaneously depict display data from the left device 12 in region 38 above the display data from the right device 12 shown in region 40. As shown in the example of FIG. 3, the amount of display data originating from one of the devices 12 and displayed by system 14 may be less than the amount of display data displayed using the same device 12 (i.e., display data of the region 34 is not displayed by the system 14). The rules may control other aspects of the depiction and/or communication of the display data from a respective display source device 12 in other embodiments.

As mentioned above, rules may be specified at the respective system 14, individual devices 12 and/or using other devices (e.g., the above described switching device). In one possible implementation where rules are specified at a respective system 14, a user may access user interface 28 to make respective outline frames of display data received from plural devices, 12. For the example of FIG. 3, the user can, at the appropriate system 14, define an outline frame comprising a top portion of display 30 to depict display data received from a first device 12 and define an outline frame for a bottom portion of display 30 to depict display data received from a second device 12. Thereafter, the display data from plural devices 12 may be simultaneously depicted in accordance with the defined rules using multimedia device 26. Other methods may be used to specify the rules.

In a more specific example, individual display source devices 12 associated with a system 14 may be assigned a unique logical name or identifier (e.g., alphabetical, numerical, etc.). Rules may be specified by manipulation of a graphical representation of relative placement of the display data from plural devices 12. For example, the system 14 may provide a menu which permits the depiction of a rule configuration screen wherein display data inputs of the respective devices 12 may be shown in reduced size form. A user may access user interface 28 to cycle through individual ones of the inputs specifying rules to control which part of the display data from a device 12 is to be depicted (and also indicate which parts are not depicted). For example, the user may utilize user interface 28 to change a size of the frame of the display data from a device 12 (e.g., using arrow keys of user interface 28) depicted in the menu to select some portions of the data and to omit other portions of the data from depiction using the multimedia device 26. Rules may be specified in accordance with different procedures in different embodiments.

Once rules are specified controlling which portions of display data will be displayed from respective devices 12, a user of the device 12 on the left may move a window into the upper portion of their respective display to allow the data to be shown by system 14 in accordance with the above-defined exemplary rule. Likewise, a user of the device 12 on the right may move a window into a lower portion of their respective display to allow the data to be shown by the system 14. Processing circuitry 22 may compose the windowed input frames to create a final display frame which may be depicted by multimedia device 26. In one example, the output of two applications (e.g., spreadsheets, CAD design applications) may be depicted in the respective upper and lower portions of the display 30 of the multimedia device 26 to facilitate comparison of the output.

In another embodiment wherein rules are specified at individual ones of devices 12, a user of one of devices 12 may wish to keep certain portions of display of the respective device 12 private without sending the display data to a system 14 (e.g., reserving a portion of screen space for instant messaging or email windows). Rules may be formulated on the respective device 12 to only allow public portions of the screen space to be transmitted to system 14. In another embodiment, an entirety of the display data of device 12 is communicated along with rules which dictate the level of access to display data of individual ones of the regions 34, 36. As described above, a user may specify outline frames of the respective screen space to set the rules. In one embodiment, Wireless Presenter software available from the Hewlett-Packard Company may be utilized to specify the rules.

As mentioned above, processing circuitry 22 may access and analyze rules regarding the depiction of display data using the respective display sink system 14 and control the depiction of the display data in accordance with the analysis. In one implementation, individual ones of systems 14 may go through a handshaking protocol with respective devices 12 to resolve respective rules. During the handshaking, system 14 may become aware of a portion of a screen of a device 12 which is to remain private. In one embodiment, bandwidth of network connections 16 may be conserved through communication of display data corresponding to public screen space and not communicating display data which is to remain private.

At times, the analysis of rules may reveal conflicts regarding the display of data in accordance with the rules. Rules received from a display source device 12 may conflict with rules internal of system 14 (e.g., specified by a user via user interface 28) and/or rules received from another display source device 12. Exemplary conflicts may include situations wherein display data from plural devices 12 or other sources can not be simultaneously depicted as specified by the respective rules. For example, one possible conflict may arise wherein rules specify depiction of respective display data from plural devices 12 at overlapping regions or locations of the display 30.

In one embodiment, processing circuitry 22 may access a policy to resolve conflicts between rules. Exemplary policies may include giving priority to rules which were established last in time, first in time, locally generated at the display sink system 14, most restrictive with respect to confidentiality, or using other policy criteria. The resolution may specify where or how the processing circuitry 22 controls the depiction of data using multimedia device 26 and whether display data received from a source display device 12 may be communicated to other recipients. In one embodiment, the resolution includes selecting one of the conflicting rules and the display data may be displayed and/or communicated according to the selected rule.

As mentioned above, display data received by one display sink system 14 (referred to as a first system 14) from one of the display source devices 12 may be communicated to another system 14 (referred to as a second system 14) for display. An exemplary implementation of first and second systems 14 may include two networked projectors at a meeting shared between two geographically distinct regions or conference rooms by multiple local and remote participants.

The display data output from first system 14 may also be defined by a user. In accordance with specified rules, the amount of display data communicated to the second system 14 may be different than the amount of display data depicted using the first display sink system 14. For example, rules generated by the source of the display data may specify that only a portion of the display data provided by a respective display source device 12 may be communicated from the first system 14 to the second system 14. The second system 14 may depict the display data received from the first system 14. In addition, if permitted by the respective rules, the second system 14 may also communicate the display data to yet another system 14 in some embodiments. Referring again to the above-described exemplary implementation, the first of systems 14 accepts display data from one or more device 12, displays it locally, and also streams at least a portion of the display data to the second system 14 for display. One possible streaming format includes NetBlade. The first system 14 may communicate all of the display data being depicted by the first system 14 or less than all of the display data depending upon established rules which may be defined at the respective system 14 and/or individual devices 12. Similar to the above-described embodiments of devices 12, one portion of the display 30 of multimedia device 26 of one system 14 may be defined as open and another portion may be defined as confidential with respect to other systems 14.

As mentioned above, one of the display source devices 12 providing display data may also communicate audible data along with the display data to the first system 14. If provided by the rules, the first system 14 may also communicate the audible data to the second system 14 for the generation of audible signals.

In accordance with the above exemplary embodiments, rules may include or one or more of the following:
Input Display source device specification (e.g., “self”, or device ID or IP address or logical name “source A”)
Input Display source region specification (e.g., pixel bounding box, application window ID,)
Input Display layout specification—where to place the input on the projected display
Output Destination specification (e.g., “all”, “other than me”, IP. address prefix (15.25*), network domain name, etc.)
Access specification: allowed/not allowed, or some numerical value indicating transparency.

An exemplary set of rules for a display sink system 14 including a projector and two display source devices 12 logically labeled A and B (with only the output of A going to other systems 14) may be:
Input A 0,0,1024,384 0,0 #show top half of A input at the origin
Input B 0,385,1024,768 0,385 #show bottom half of B input starting at 0,385
Output A all
Output B none

Accordingly, exemplary network systems 10 described herein may handle various digital and analog video formats as well as general multi-source multi-destination media multiplexing tasks. Some arrangements implement communications according to rules as if they are properties of appliances or devices such as display source devices 12 and multimedia devices 26. Other arrangements may permit control access at an application level. For example, a user of a device 12 may present slides at a sit-down meeting and may also want to check email without displaying the contents of their inbox via the multimedia device 26 of the system 14. The rules of the respective device 12 may specify that only certain application displays (e.g., PowerPoint) are shared with the system 14. A less-restrictive specification may be to only disallow display of an application display (e.g., Outlook). Some windowing graphical applications have names and unique window identifiers which may be used for reference. Programming may be provided in devices 12 wherein regular expressions may be used to assign rules for certain applications (e.g., “Outlook” may refer to all Microsoft Outlook windows). In one implementation, the rules may be active in the operating system space (e.g., GDI layer) to send system 14 appropriate window displays while sending restricted windows to the respective local device 12 (e.g., local video memory only). In another arrangement, a presenter using a device 12 may specify a rule that shows presentation notes via the respective device 12 (e.g., as a overlay on a laptop screen) while sending only the presentation slide display to a system 14.

At least some aspects of the disclosure allow multiple display source devices 12 to be shared simultaneously on a display sink system 14 without re-selection or reconfiguration of inputs. In addition, users are provided with control over how display data is input to, output from, streamed and/or shared between networked display sink systems 14. Multiplexing and compositing multiple display inputs from a plurality of display source devices 12 is provided for a single display of a display sink system 14 in accordance with exemplary aspects of the disclosure.

At least some advantages of some aspects of the disclosure become apparent in network systems 10 involving multiple display sink systems 14 in different locations (e.g., different rooms during a multi-room collaboration or networked gaming session). The displays 30 of display sink systems 14 configured in accordance with aspects of the disclosure may be thought of as addressable space that display source devices 12 may target (e.g., a display source device 12 may specify its respective output should go to a particular region of a particular projector).

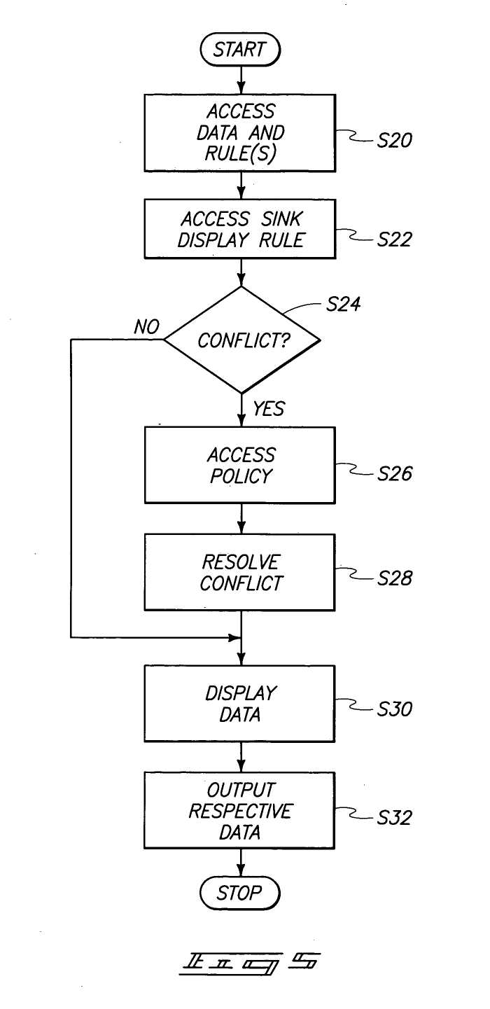

Referring to FIG. 4, an exemplary method performed by a display source device 12 is shown according to one embodiment. Other methods are possible including more, less or alternative steps.

At a step S10, a user may specify a public space of a display of the display source device. The public space may include an entirety of a display of the display source device or less than an entirety (e.g., the public space may correspond to a region 36 of FIG. 3 which may be defined as public).

At a step S12, a user may specify a rule corresponding to accessibility of display data within the public space. The rule may define which recipients are permitted to display the display data, control communication of the display data, define the regions of the display of the display sink system wherein the display data is to be depicted, etc.

At a step S14, processing circuitry of the display source device may determine whether display data is present within the public space defined in step S10.

If the analysis of step S14 is affirmative, the display source device may proceed to step S16 to output the display data within the public space as well as the respective rule for communication to an appropriate recipient.

Referring to FIG. 5, an exemplary method performed by processing circuitry 22 of a display sink device 14 is shown according to one embodiment. Other methods are possible including more, less or alternative steps.

At a step S20, display data and respective source display rules received by the communications interface may be accessed by the processing circuitry of the display sink system.

At a step S22, the processing circuitry may access sink display rule(s).

At a step S24, the processing circuitry may determine whether controlling the depiction of the received display data in accordance with the source display rules and/or sink-display rules will result in a conflict.

If the analysis of step S24 is negative, the process may proceed to a step S30 wherein the display data is depicted in accordance with the rules.

If the analysis of step S24 is affirmative, the process may proceed to a step S26 to access a policy to resolve the conflict.

At a step S28, the conflict is resolved in accordance with the policy. In another embodiment, if the policy provides an insufficient resolution, if a proper policy is not available, or for other reasons, the method may also poll user(s) of device(s) 12 and/or system 14 with respect to resolution of the conflict. Thereafter, the user may enter a resolution to the conflict or modify the resolution provided by the policy.

At a step S30, the processing circuitry controls the display of the display sink system to depict the display data in accordance with any resolutions if appropriate.

At a step S32, the processing circuitry may control communication of at least a portion of the received display data and respective rules to another display sink system or other recipient if appropriate as specified by the rules.

The protection sought is not to be limited to the disclosed embodiments, which are given by way of example only, but instead is to be limited only by the scope of the appended claims.

What is claimed is:

1. A data display method comprising:
providing a plurality of display source devices;
providing a display sink system configured to depict visual images;
specifying a source display rule associated with display data of one of the display source devices, wherein the source display rule is configured to control the depiction of the display data of the respective one of display source devices by the display sink system;
specifying a sink display rule configured to control the display of images using the display sink system;
outputting the display data of the one of the display source devices and the source display rule for communication to the display sink system;
analyzing the source display rule and the sink display rule; and
using the display sink system, depicting the display data of the one of the display source devices responsive to the analyzing.

2. The method of claim 1 wherein the specifying the source display rule specifies where the display data of the one of the display source devices is to be displayed using the display sink system.

3. The method of claim 1 wherein the analyzing comprises:
identifying a conflict between the source display rule and the sink display rule with respect to depiction of the display data of the one of the display source devices using the display sink system;
selecting one of the source display rule and the sink display rule responsive to the identification of the conflict; and
wherein the depicting comprises depicting the display data of the one of the display source devices according to the selected one of the source display rule and the sink display rule.

4. The method of claim 3 wherein the selecting comprises accessing a policy for resolving the conflict and selecting the one of the source display rule and the sink display rule according to the policy.

5. The method of claim 1 wherein the source display rule and the sink display rule individually define the locations of a display of the display sink system for depicting display data.

6. The method of claim 1 wherein the specifying the source display rule comprises specifying using the one of the display source devices.

7. The method of claim 1 further comprising, using the display sink system, simultaneously depicting display data of another of the display source devices along with the depicting of the display data of the one of the display source devices.

8. The method of claim 1 further comprising depicting an amount of display data using the one of the display source devices, and wherein an amount of the display data of the one of the display source devices depicted using the display sink system is less than the amount of display data depicted using the one of the display source devices.

9. A data display method comprising:
providing a plurality of display source devices;
providing display data using one of the display source devices;
specifying a source display rule associated with the display data using the one of the display source devices;
providing a first display sink system configured to depict visual images;
first communicating the display data and the source display rule to the first display sink system;
depicting the display data using the first display sink system; and
after the first communicating, second communicating the display data from the first display sink system to a second display sink system according to the source display rule.

10. The method of claim 9 wherein the first communicating comprises communicating additional display data from the one of the display source devices to the first display sink system, the depicting comprises depicting the additional display data using the first display sink system, and further comprising withholding the additional display data from the second communicating according to the source display rule.

11. The method of claim 9 wherein the depicting comprises depicting the display data at a predefined location of a display of the first display sink system according to the source display rule.

12. The method of claim 9 further comprising depicting the display data using the second display sink system according to the source display rule.

13. The method of claim 9 further comprising:
providing audible data using the one of the display source devices;
communicating the audible data to the first and second display sink systems; and
generating audible signals using the first and second display sink systems.

14. The method of claim 9 further comprising accessing a sink display rule, and wherein the second communicating comprises communicating according to the sink display rule.

15. The method of claim 9 wherein the specifying comprises identifying a portion of a display of the display source device, and associating the source display rule with the display data corresponding to the portion of the display.

16. The method of claim 9 wherein the source display rule controls the first and second communicatings responsive to the first and second display sink systems satisfying criteria of the source display rule.

17. The method of claim 9 wherein the display data comprises metadata.

18. A data display method comprising:
providing display data using a plurality of display source devices;
providing a display sink system configured to depict visual images;
using the display source devices, specifying a plurality of source display rules associated with respective display data of the respective display source devices and configured to control the depiction of the respective display data by the display sink system;
using the display source devices, communicating the respective display data and the respective source display rules to the display sink system;
using the display sink system, specifying a plurality of regions of a display to depict respective display data of the display source devices, wherein the specifying comprises specifying using the source display rules; and
using the display sink system, generating an image comprising the display data of the display source devices positioned at the respective regions of the display.

19. The method of claim 18 further comprising:
identifying a conflict between the source display rules of the display source devices with respect to depiction of the display data using the display sink system;
selecting one of the source display rules responsive to the identification of the conflict; and
wherein the generating comprises generating the image according to the selected one of the source display rules.

20. The method of claim 19 wherein the selecting comprises accessing a policy for resolving the conflict and selecting the one of the source display rules according to the policy.

21. The method of claim 18 wherein the display sink system comprises a first display sink system, and further comprising communicating the display data from one of the display source devices to a second display sink system according to the source display rule of the one of the display source devices.

22. The method of claim 21 further comprising retaining the display data from an other of the display source devices internally of the first display sink system without communication to the second display sink system.

23. A display system comprising:
a display device configured to depict visual images to be viewed by a user;
a communications interface configured to receive display data and a respective source display rule, wherein the display data corresponds to an image to be generated by the display device and the source display rule is configured to control the depiction of the display data by the display device; and
processing circuitry configured to access the source display rule, to identify a conflict with respect to depiction of the display data using the display device in accordance with the source display rule, to resolve the conflict, and to control the display device to depict the image corresponding to the display data in accordance with the resolution of the conflict.

24. The system of claim 23 wherein the display data and source display rule are generated by a first display source device, and the processing circuitry is configured to identify the conflict comprising a conflict of the depiction of the display data of the first display source device with respect to the depiction of display data of a second display source device.

25. The system of claim 24 wherein the second display source device is configured to provide another source display rule configured to control the depiction of the display data of the second display source device, and the conflict comprises a conflict between the source display rules of the first and second display source devices.

26. The system of claim 23 wherein the processing circuitry is configured to identify the conflict comprising a conflict between a sink display rule and the depiction of the display data of the display source device in accordance with the source display rule.

27. The system of claim 23 wherein the processing circuitry is configured access a policy responsive to the identification of the conflict, and to resolve the conflict according to the policy.

28. The system of claim 23 wherein the display device comprises a projector.

29. The system of claim 28 wherein the communications interface comprises a wireless interface configured to receive the display data and the respective source display rule via wireless communications signals.

30. A network system comprising:
first display means for accessing display data from a plurality of display source devices, for accessing a plurality of display rules for controlling the depicting of the display data of the display source devices, and for simultaneously depicting the display data of the display source devices according to the display rules;
second display means for accessing the display data of at least some of the display source devices from the first display means and for depicting the display data accessed by the second display means; and
wherein the first display means comprises means for identifying the some display data for communication to the second display means and for withholding communication of a remaining amount of the display data from communication to the second display means.

31. The system of claim 30 wherein the first display means uses the display rules for identifying the some display data for communication to the second display means.

32. The system of claim 31 wherein the first display means uses the display rules comprising source display rules for the identifying the some display data for communication to the second display means.

33. The system of claim 30 wherein the first display means comprises means for accessing the display rules comprising source display rules from the display source devices.

34. The system of claim 33 wherein the first display means further comprises means for accessing the display rules comprising sink display rules.

35. An article of manufacture comprising:
media comprising programming configured to cause processing circuitry to:
access first display data from a first display source;
access second display data from a second display source;
access a first source display rule configured to control the depiction of the first display data using a display;
access a second source display rule configured to control the depiction of the second display data using the display;
identify a plurality of regions of a display to depict respective ones of the first display data and the second display data according to the first and second source display rules; and
control the simultaneous depiction of the first and second display data at the respective regions of the display.

36. The article of claim 35 wherein the media further comprises programming configured to cause processing circuitry to access a sink display rule and to control the depiction of the first and second display data according to the sink display rule.

37. The article of claim 35 wherein the processing circuitry comprises processing circuitry of a first display sink system and the media further comprises programming configured to cause the processing circuitry to output one of the first and second display data for depiction using a second display sink system.

38. The article of claim 35 wherein the processing circuitry comprises processing circuitry of a first display sink system and the media further comprises programming configured to cause processing circuitry to communicate one of the first and second display data to a second display sink system and to not communicate the other of the first and second display data according to the first and second display rules.
